(19) United States
(12) Patent Application Publication
(10) Pub. No.: US 2021/0194027 A1
(43) Pub. Date: Jun. 24, 2021

(54) REAL TIME HYDROGEN SELF-SUPPLIED ALKALINE MEMBRANE FUEL CELL STACK

(71) Applicant: The Florida State University Research Foundation, Inc., Tallahassee, FL (US)

(72) Inventors: Jose Viriato Coelho Vargas, Curitiba (BR); Juan Carlos Ordonez, Tallahassee, FL (US); Jose Eduardo Ferreira da Costa Gardolinski, Almelo (NL); Zohrob Hovsapian, Idaho Falls, ID (US); Rodrigo Cesar Raimundo, Curitiba (BR)

(21) Appl. No.: 17/127,096

(22) Filed: Dec. 18, 2020

Related U.S. Application Data
(60) Provisional application No. 62/949,799, filed on Dec. 18, 2019.

(51) Int. Cl. H01M 8/0606; H01M 8/106; H01M 8/1004; H01M 8/04089; H01M 8/1048; H01M 8/083

(52) U.S. Cl. CPC H01M 8/0606; H01M 8/106; H01M 8/1004; H01M 2300/0014; H01M 8/1048; H01M 8/083; H01M 8/04089

(57) ABSTRACT

Disclosed herein are real time hydrogen self-supplied alkaline membrane fuel cell that operates with hydrogen produced in situ. The hydrogen self-supplied alkaline membrane fuel cell can comprise (i) a hydrogen generation reactor that provides continuous, on-demand supply of hydrogen, wherein the hydrogen generation reactor produces hydrogen by reacting metal particles with water in the presence of an alkaline catalyst, and (ii) a membrane electrode assembly adapted to receive an oxidant and a fuel stream containing hydrogen produced in the hydrogen generation reactor. The membrane electrode assembly comprises an electrolyte membrane and at least two electrodes. The electrolyte membrane can comprise cellulose and the electrolyte can comprise a base such as aqueous potassium hydroxide. Methods for operating an alkaline membrane fuel cell are also disclosed.

### CROSS REFERENCE TO RELATED APPLICATIONS

This application claims priority to U.S. Provisional Patent Application No. 62/949,799, filed Dec. 18, 2019, the content of which is herein incorporated by reference in its entirety.

### FIELD

This disclosure relates generally to sustainable alkaline membrane fuel cell stack.

### BACKGROUND

Human population is expected to reach 9 billion people by 2050, i.e., roughly a 28% increase over the current 7 billion feature. Society is also increasingly energy dependent from different sources so that a 56% growth in energy demand is expected up to 2050. Nonrenewable sources, i.e., fossil fuels are responsible for more than 80% of the current energy supply, but are depleting, and collaterally produce carbon emissions that increase greenhouse gas emissions (GHG) that contribute to global warming. Efforts have been made to explore new fossil fuel repositories (e.g., oil and gas discoveries in the pre-salt layer, natural gas) so that the supplies of fossil fuels are likely to remain adequate for the next few generations, but unacceptable environmental long-term consequences are expected, and scientists and policy makers must search for alternative sources of energy. In order to meet the increasing energy consumption, it is necessary to produce more energy and preferably in a sustainable process.

Fuel cells transform fuel chemical energy directly into electrical energy electrochemically, with high efficiency, which is a simple silent and low emissions process. Historically, the alkaline electrolyte was the first practical technology that made the hydrogen derived electricity generation possible. Among the drawbacks is the liquid electrolyte, that requires efficient sealing. Also, pure oxygen is needed to avoid the formation of potassium carbonate, since the potassium hydroxide (KOH) solution reacts with carbon dioxide (CO2) causing the so called “poisoning” effect. Currently, the Proton Exchange Membrane Fuel Cell, PEMFC, is probably the most popular FC, being a low-temperature fuel cell. Although PEMFC has been used in several applications, like vehicular, for example, there are limiting characteristics, i.e., water utilization, and high costs of platinum and Nafion membrane. More recently, the anionic exchange membrane (AEM) was developed in order to effectively replace the liquid electrolyte in the AFC.

Membranes in alkaline cells are thought to have the potential to overcome several disadvantages observed in other existing fuel cells, due to expected lower corrosion than acid FC, resulting in extended life and a faster oxygen reduction reaction (ORR) than PEMFC. AMFC has the potential to be more favorable for power generation than PEMFC. However, since the AMFC is still at an early development stage, two essential aspects need to be investigated: i) the development of high performance ionic membranes, and ii) the obtaining of efficient non-precious electrode catalysts. Regarding the membrane, dating back to 1950's, the electrolyte was immobilized by soaking it up in a simple disc of filter paper saturated with a KOH solution. Next, an asbestos separator was utilized to support the KOH solution, and finally solid anionic membranes which contain ammonia, that also avoided carbon dioxide poisoning. However, ammonia toxicity and flammability, and asbestos being a known carcinogenic agent are still issues to be solved for a better acceptance of the technology.

In general, fuel cells would have a predominant role in a possible future scenario of a global hydrogen economy. However, it was believed that, despite its virtues, hydrogen was likely to remain a distraction from the real, practical solutions to humanity energy needs, and justified it by pointing out that big issues such as production, storage and transportation need to be overcome. Nevertheless, hydrogen has the versatility to be used in a variety of applications and the highest mass basis lower heating value, and is a clean form of energy. The element hydrogen is very abundant on earth, but only exists as a molecular component in many substances such as water, therefore, some chemical process must be used in order to obtain the molecule H2. For that, there are several known hydrogen acquisition technologies that can be chemical, biological, electrolytic, photolytic, and also by thermochemical processes. Although hydrogen production is theoretically simple by splitting the water molecule to generate hydrogen and oxygen (e.g., electrolysis, plasmolysis, thermolysis, biocatalytic decomposition, radiolysis), the most utilized process is H2 production using fossil fuels through steam reforming of methane (SRM), i.e., natural gas, which produces GHG emissions. Globally, 90% of the produced hydrogen is from SRM, increasing to 95% in the USA. Considering technical and economic aspects, it is generally accepted that SRM is the most used technique to produce H2. However, SRM demands high heat input, thus effective reactor heat supplying strategies are required.

Due to the high temperature demand, from 700° C. to 900° C., SRM is also considered as a high cost process. Additionally, high CO₂ production that is driven to the atmosphere is a major hurdle to overcome. Due to high availability, in the long term hydrogen could be obtained from water. The low temperature water electrolysis (WE) breaks water into hydrogen and oxygen, using an electrolyzer. The hydrogen produced by WE is available for storage and direct use, differently from SRM, which must be treated before use. However, electricity is required, and electrolysis cells costs have prevented the technology success at the large scale, restricting its use to the chemical industry. Besides SRM and WE, all other hydrogen-production technologies are at the early development stage. As a result, the development of a production process that is feasible and makes hydrogen economically competitive with fossil fuels is still needed. The devices, systems, compositions, and methods described herein address these and other needs.

### SUMMARY

Disclosed herein are real time hydrogen self-supplied alkaline membrane fuel cell that operates with hydrogen produced in situ. The hydrogen self-supplied alkaline membrane fuel cell can comprise (i) a hydrogen generation reactor that provides continuous, on-demand supply of hydrogen, wherein the hydrogen generation reactor produces hydrogen by reacting metal particles with water in the presence of an alkaline catalyst, and (ii) a membrane electrode assembly adapted to receive an oxidant and a fuel stream containing hydrogen produced in the hydrogen generation reactor. The membrane electrode assembly comprises an electrolyte membrane and at least two electrodes. The electrolyte membrane can comprise cellulose and the electrolyte can comprise a base such as aqueous potassium hydroxide.

As described herein, the hydrogen generation reactor produces hydrogen by reacting metal particles with water in the presence of an alkaline catalyst. The metal particles used in the hydrogen generation reactor can be selected from the group consisting of aluminum, magnesium, silicon, zinc, and combinations thereof. In some examples, the metal particles can comprise aluminum, such as aluminum from a post-consumer waste product. In some examples, the metal particles consist of aluminum. The metal particles can have an average particle size diameter of less than 10,000 microns, e.g., from 0.01 micron to 10,000 microns or from 0.01 micron to 1,000 microns.

The alkaline catalyst can comprise a strong base. Examples of strong bases include sodium hydroxide, potassium hydroxide, or a mixture thereof. In some examples, the alkaline catalyst comprise sodium hydroxide.

The hydrogen generation reactor can be a hydrogen generation batch reactor which receives intermittent supply of water, alkaline catalyst, and metal particles. Preferably, all or substantially all of the metal particles react at the end of each reaction cycle (or at the end of a batch reaction). In some embodiments, the hydrogen generation reactor can be self-cleaning at the end of each operation cycle, prior to receiving another supply of reactants. A self-cleaning method can include removing unreacted metal particles or by-products such as metal hydroxide from the reactor. The self-cleaning process is preferably automatic. For example, the hydrogen generation reactor can include an appropriately sized scraping and bottom door programmable mechanism that facilitate automatic removal of unreacted materials and/or by-products. In some embodiments, the unreacted materials or by-product can be directed to an external metal recycling chain, this allowing a new batch of metal particles to be provided to the hydrogen generation reaction in a sustainable, energy cycle. In some embodiments, the self-cleaning method can include controlling the reaction between the metal particles and water to provide substantially pure hydrogen. In other embodiments, the self-cleaning method can include purifying the hydrogen produced from the hydrogen generation reactor to reduce contamination in the membrane electrode assembly.

As described herein, the membrane electrode assembly can comprise at least two electrodes, including an anode and a cathode on opposite sides of the electrolyte membrane. In some cases, the at least two electrodes comprise platinum, carbon, a transition metal such as iron, cobalt, or nickel at the anode, and silver, or iron phthalocyanine at the cathode. The membrane electrode assembly can be configured to receive fuel from the hydrogen generation reactor and an oxidant, and allow for the fuel and the oxidant to react in the at least two electrodes and anions to flow through an electrolyte. The electrolyte is preferably potassium hydroxide. The oxidant can be oxygen, preferably derived from atmospheric air. The membrane electrode assembly can be further configured to remove carbon dioxide from the oxidant, preferably via an external aqueous potassium hydroxide solution. The membrane electrode assembly further includes a cellulose-containing electrolyte membrane, preferably in the form of cotton fibers or paper.

The fuel cell described herein is capable of producing hydrogen on demand, at any fuel cell operating flow regime, using appropriate amounts or appropriately sized containers of water, sodium hydroxide and metal particles containers.

Methods for operating an alkaline membrane fuel cell are also disclosed. The method can include generating hydrogen from a hydrogen generation reactor that provides continuous, on-demand supply of hydrogen, wherein the hydrogen generation reactor produces hydrogen by reacting metal particles selected from the group consisting of aluminum, magnesium, silicon, zinc, and combinations thereof, with water in the presence of an alkaline catalyst; supplying a continuous, on-demand flow of fuel comprising hydrogen generated to a membrane electrode assembly adapted to receive an oxidant and a fuel stream containing the hydrogen generated in the hydrogen generation reactor, wherein hydrogen is generated at any fuel cell operating flow regime; generating water and power in the fuel cell, and using at least some of the water generated from step c) to resupply water for the generation of hydrogen in step a).

Additional advantages will be set forth in part in the description that follows or may be learned by practice of the aspects described below. The advantages described below will be realized and attained by elements and combinations particularly pointed out in the appended claims. It is to be understood that both the foregoing general description and the following detailed description are exemplary and explanatory only and are not restrictive.

### DESCRIPTION OF THE FIGURES

FIG. 1 is a schematic diagram shown a sustainable process flow chart.

FIG. 2 is a diagram showing fuel cell brass plate.

FIG. 3 is a diagram showing fuel cell assembly.

FIG. 4 shows commercial and residual aluminum.

FIG. 5 is a graph showing polarization curve for AMFC.

FIG. 6 is a graph showing polarization curve for SAMFC with hydrogen from commercial aluminum.

FIG. 7 is a graph showing polarization curve for SAMFC with hydrogen from waste soda can aluminum.

### DETAILED DESCRIPTION

Provided herein are compositions, devices, systems, and methods for real time hydrogen self-supplied alkaline membrane fuel cell that operates with hydrogen produced in situ. The compositions, devices, systems, and methods described herein may be understood more readily by reference to the following detailed description of specific aspects of the disclosed subject matter and the Examples included herein and to the Figures.

Before the present compositions, devices, systems, and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

General Definitions

In this specification and in the claims that follow, reference will be made to a number of terms, which shall be defined to have the following meanings:

Throughout the description and claims of this specification the word “comprise” and other forms of the word, such as “comprising” and “comprises,” means including but not limited to, and is not intended to exclude, for example, other additives, components, integers, or steps. As used in the description and the appended claims, the singular forms “a,” “an,” and “the” include plural referents unless the context clearly dictates otherwise. Thus, for example, reference to “a composition” includes mixtures of two or more such compositions, reference to “an organosilane” includes mixtures of two or more such organosilanes, reference to “the silane” includes mixtures of two or more such silanes, and the like. “Optional” or “optionally” means that the subsequently described event or circumstance can or cannot occur, and that the description includes instances where the event or circumstance occurs and instances where it does not. For example, statements about a device that optionally contains a check valve refers to devices that have a check valve and devices that do not have a check valve.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed that “less than or equal to” the value, “greater than or equal to the value” and possible ranges between values are also disclosed, as appropriately understood by the skilled artisan. For example, if the value “10” is disclosed, then “less than or equal to 10” as well as “greater than or equal to 10” is also disclosed. It is also understood that throughout the application data are provided in a number of different formats and that this data represent endpoints and starting points and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

References in the specification and concluding claims to parts by weight of a particular element or component in a composition denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent (wt. %) of a component, unless specifically stated to the contrary, is based on the total weight of the formulation or composition in which the component is included.

Devices and Methods

Disclosed herein are devices and methods for real time hydrogen self-supplied alkaline membrane fuel cell that operates with hydrogen produced in situ. The fuel cell can comprise a hydrogen generation reactor that provides continuous, on-demand supply of hydrogen and a membrane electrode assembly. The hydrogen generation reactor produces hydrogen by reacting metal particles with water in the presence of an alkaline catalyst. Each of the metal particles, water, and alkaline catalyst can be provided to a reaction chamber of the hydrogen generation reactor from separate, appropriately sized containers.

The metal particles used in the hydrogen generation reactor can be selected from a group I, II, or III metal, or a transition metal. In some examples, the metal particles can be selected from the group consisting of aluminum, magnesium, silicon, zinc, and combinations thereof. The metal particles can be from a post-consumer waste product, such as aluminum from a post-consumer waste product including aluminum cans and other aluminum containers, aluminum foils and other disposable aluminum products. In some examples, the metal particles consist essentially of, or consists of aluminum. The metal particles can be present as in its atomic form, an alloy, an oxide, a salt, or a mixture thereof.

The metal particles preferably has small particle sizes. For example, the metal particles preferably have an average particle size diameter of less than 10,000 microns. In some embodiments, the metal particles can have an average particle size diameter of less than 9,000 microns, less than 8,000 microns, less than 7,000 microns, less than 6,000 microns, less than 5,000 microns, less than 4,000 microns, less than 3,000 microns, less than 2,000 microns, less than 1,000 microns, less than 800 microns, or less than 500 microns. In some embodiments, the metal particles can have an average particle size diameter of from 0.01 micron to 10,000 microns, from 0.01 micron to 8,000 microns, from 0.01 micron to 5,000 microns, from 0.01 micron to 2,000 microns, from 0.01 micron to 1,000 microns, from 1 micron to 10,000 microns, from 1 micron to 1,000 microns, or from 1 micron to less than 1,000 microns.

The alkaline catalyst preferably includes a strong base, having a pH of 10 or greater. For example, the alkaline catalyst can have a pH of 10.5 or greater, 11 or greater, 11.5 or greater, 12 or greater, 12.5 or greater, or 13 or greater. Examples of such strong bases are selected from sodium hydroxide, potassium hydroxide, or a mixture thereof. Preferably, the alkaline catalyst comprises potassium hydroxide.

The metal particles, such as aluminum preferably react with the strong base such as a hydroxide containing solution at or near room temperature, with the production of hydrogen gas and optionally the formation of reaction by-products at the bottom of the reactor. The reaction temperature, however, can be elevated to 30° C. or greater, 35° C. or greater, 40° C. or greater, 45° C. or greater, 50° C. or greater, 55 or greater, or 60° C. or greater. In some examples, the reaction temperature can be 100° C. or less, 90° C. or less, 85° C. or less, 70° C. or less, 65° C. or less, 60° C. or less, 50° C. or less, 45° C. or less, 40° C. or less, 35° C. or less, 30° C. or less, or 25° C. or less.

In some examples, water and aluminum react in presence of sodium hydroxide at room temperature to produce hydrogen and aluminum hydroxide, which is environmentally benign. The strong alkaline catalysts can eliminate passive oxide formed on the surface of the metal (aluminum) surface formed for example, when exposed to air and water. The reaction can be described as follows:

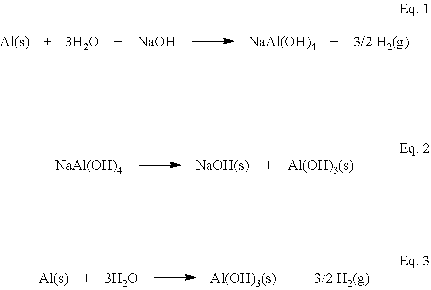

The reaction can occur in two steps according to Eqs. (1) and (2). The overall reaction is shown in Eq. (3). The product Al(OH)₃ can be recycled to originate aluminum salts or hydroxides in pharmaceuticals or return to the aluminum recycling chain. Equation (1) requires the catalysts sodium or potassium hydroxide, that are fully recoverable, as shown in Eq. (2).

In some cases, the reaction for hydrogen generation from water via metal particles such as aluminum can be affected by passivation. However, passivation can be reduced or eliminated using fine particle size metal components, saltwater, stronger base, among other means. For example, it has been shown that hydrogen production by corrosion of aluminum in seawater suspensions prepared with NaAlO₂ prevented aluminum passivation during hydrogen evolution. A synergistic effect of Al(OH)₃ suspensions together with NaAlO₂ solutions had a major positive effect for aluminum corrosion. Additional results confirmed that aluminum passivation was substantially avoided when using NaOH in combination with seawater. The effect of the salt (NaCl) in aqueous suspensions was found negligible in comparison to the aluminum passivation reduction.

The hydrogen generation reaction can be carried out either as a batch, semi-batch, or continuous process. The process can use a single reactor or a series of reactors as would be readily understood by those skilled in the art. In some instances, it may be preferable to use horizontal type reactors which are designed to agitate the reactants well therein and to transport the reactants and/or products. The hydrogen generation reaction can be carried out by first charging a reactor with suitable metal particles and water. The initial charge can then optionally be heated to a temperature at or near the reaction temperature. As described herein, the reaction temperature can be, for example, room temperature (about 25° C.) or greater (e.g., between 25° C. and 100° C.).

After the initial charge, the metal particles and optionally water can be continuously fed to the reactor in one or more feed streams. A catalyst feed stream can also be continuously added to the reactor at the time the metal particle feed stream is added although it may also be desirable to include at least a portion of the catalyst to the reactor before adding a metal particle stream. The metal particle, water, and catalyst feed streams are typically continuously added to the reactor over a predetermined period of time (e.g., 0.5 to 24 hours) to cause reaction of the metal particles with water and to thereby produce the hydrogen gas fuel.

In some embodiments, the hydrogen generation reactor can be a hydrogen generation batch reactor. In a batch reactor, a batch of reactants including water, catalyst, and metal particles are held in the reaction chamber where they react, producing hydrogen. Simultaneously, the hydrogen can be separated from the mixture by permeation through an integrated selective membrane. Such a membrane can be used to purify the hydrogen gas emitted from the reaction. These processes proceed to the desired level of completion at which point the reaction chamber is exhausted and a fresh batch of fuel mixture brought in.

The batch reactor allows for an intermittent supply of water, alkaline catalyst, and metal particles. Preferably, all or substantially all of the metal particles react at the end of each reaction cycle (or at the end of a batch reaction). In some embodiments, the hydrogen generation reactor can be self-cleaning at the end of each operation cycle, prior to receiving another supply of reactants. After self-cleaning, the reactor can be re-supplied with a fresh batch of reactant automatically, and the cycle continues, which characterizes a loading, reaction and self-cleaning cyclic operation. In this way, hydrogen can be produced continuously for fuel cell continuous operation on demand

A self-cleaning method can include removing unreacted metal particles or by-products such as metal hydroxide from the reactor. The self-cleaning process is preferably automatic. For example, the hydrogen generation reactor can include an appropriately sized scraping and bottom door programmable mechanism that facilitate automatic removal of unreacted materials and/or by-products. The reaction between the metal particles and water produces metal hydroxide by-product. In some embodiments, unreacted materials and/or by-products can be directed to an external metal recycling chain, this allowing a new batch of metal particles to be provided to the hydrogen generation reaction in a sustainable, energy cycle.

The self-cleaning method can include controlling the reaction between the metal particles and water to provide substantially pure hydrogen. In other embodiments, the method can include purifying hydrogen produced from the hydrogen generation reactor to reduce contamination in the membrane electrode assembly.

Several design features of the hydrogen generation reactor can provide very clean operation of the hydrogen generation process. The reactor design and the hydrogen generation process as described herein can be used in combination to produce hydrogen continuously and on demand The reactor can preferably operate for greater than 10 runs, greater than 50 runs, greater than 100 runs between self-cleaning cycles. In addition to the long operation time between cleaning, cleaning is made less onerous by the self-cleaning capability of the reactor. The combination of in-situ self-cleaning capability, inherently clean operation and long times between cleaning cycles decrease the down time required for cleaning and increase throughput.

As described herein, the disclosed compositions, methods, and devices can be used to generate hydrogen. As such, they can be used as a source of hydrogen fuel for fuel cells. Generally, the disclosed compositions, methods, and devices can be used to supply hydrogen to any type or design of fuel cell that uses hydrogen as fuel. One of skill in the art will recognize that there are many ways to supply the hydrogen gas produced by the disclosed compositions, methods, and devices to a fuel cell. For example, the hydrogen outlet of the hydrogen generation reactor can be connected to a fuel cell in such a way that the hydrogen produced from the reactor is supplied to an electrode of the fuel cell. Such a configuration can be replicated so as to supply hydrogen to the electrodes of more than one fuel cell (e.g., as is the case with stacks of fuel cell). In other examples, the hydrogen outlet can be connected to a reformer of fuel cell (or to several reformers of multiple fuel cells). A reformer is a component of a fuel cell where hydrogen gas (or some other fuel) is reformed with steam or oxygen to produce a “fuel gas,” which is then fed to an electrode of a fuel cell for power generation. It is also contemplated that the connection between the hydrogen outlet and a fuel cell (or fuel cell reformer) can also be fitted with a valve or pump to control the amount (e.g., volume or pressure) of hydrogen that enters the fuel cell or fuel cell reformer.

In some aspects, the fuel cell comprises a membrane electrode assembly, which can be adapted to receive an oxidant and a fuel stream containing hydrogen produced in the hydrogen generation reactor. The membrane electrode assembly comprises an electrolyte membrane and at least two electrodes. The at least two electrodes can comprise an anode and a cathode on opposite sides of the electrolyte membrane. The electrodes can be made of any suitable material. In some embodiments, the at least two electrodes comprise platinum, carbon, a transition metal such as iron, cobalt, nickel, silver, or iron, phthalocyanine, or a combination thereof. For example, the at least two electrodes can comprise a transition metal such as iron, cobalt, or nickel at the anode, and silver or iron phthalocyanine at the cathode.

The membrane electrode assembly can be configured to receive fuel from the hydrogen generation reactor and an oxidant, and allow for the fuel and the oxidant to react in the at least two electrodes and anions to flow through an electrolyte. The electrolyte is preferably a metal hydroxide such as potassium hydroxide. The anions produced from reaction of the fuel and oxidant can flow through the electrolyte.

The oxidant can be oxygen, preferably derived from atmospheric air. The membrane electrode assembly can be further configured to remove carbon dioxide from the oxidant, preferably via an external aqueous potassium hydroxide solution. This external component avoids the so called “cell poisoning” effect, allowing for the alkaline fuel cell to operate with atmospheric air instead of pure oxygen at an unnecessary additional cost.

As described herein, an electrolyte membrane can separate the two electrodes. The electrolyte membrane can be derived from any suitable material, preferably cellulose. In some examples, the cellulose in the electrolyte membrane can be in the form of cotton fibers or paper.

Overall, the fuel cell is capable of producing hydrogen on demand, at any fuel cell operating flow regime, using appropriate amounts or sized contained of water, sodium hydroxide and metal particles containers.

The production of fuel cells is known in the art. For example, a fuel cell can be produced as described in U.S. Pat. Nos. 6,733,916; 6,399,235; 6,348,278; 6,106,963; 6,087,033; 6,080,503; 5,328,779; 5,273,837; 5,741,408: 5,508,128; 5,079,103, which are all incorporated by reference herein at least for their teachings of fuel cell fabrication and manufacture.

Methods

Methods for operating an alkaline membrane fuel cell are also disclosed. The method can include generating hydrogen from a hydrogen generation reactor that provides continuous, on-demand supply of hydrogen, wherein the hydrogen generation reactor produces hydrogen by reacting metal particles selected from the group consisting of aluminum, magnesium, silicon, zinc, and combinations thereof, with water in the presence of an alkaline catalyst; supplying a continuous, on-demand flow of fuel comprising hydrogen generated to a membrane electrode assembly adapted to receive an oxidant and a fuel stream containing the hydrogen generated in the hydrogen generation reactor, wherein hydrogen is generated at any fuel cell operating flow regime; generating water and power in the fuel cell, and using at least some of the water generated from step c) to resupply water for the generation of hydrogen in step a).

The continuous, on-demand generation of hydrogen desirably generates and releases a flow of hydrogen gas on a substantially as-needed basis by the fuel cell, and desirably at a substantially constant pressure. These features are achieved, in part, by various self-cleaning mechanisms as described herein. In this regard it is to be noted that, as used herein, the terms “on-demand” or “substantially as-needed basis” generally refers to a hydrogen gas generation device that produces or generates hydrogen gas when needed by the fuel cell of which it is a part (or to which it is in communication with), such as for example when the device receiving power from the fuel cell is turned on or in the active mode, and therefore does not simply produce or generate hydrogen once activated until all of the hydrogen-generating fuel is consumed, thus optionally eliminating or limiting the need for (i) a tank to hold the hydrogen that is generated (for later consumption or use), and/or (ii) the need for the ability to safely vent hydrogen gas when the device is not in use. In some embodiments, the reactor can provide a substantially constant flow of hydrogen gas, which when active (i.e., when the reaction that generates the hydrogen gas is occurring), is capable of releasing a flow of hydrogen gas at a particular target pressure (e.g., about 5 psi or greater, about 10 psi or greater, about 15 psi or greater, about 20 psi or greater, or even about 25 psi or greater) that varies over a period of time (e.g., at least about 1 hour) by less than about 25% (e.g., less than about 10%, less than about 8%, less than about 6%, less than about 4%, or even less than about 2%), until substantially all of the fuel from which the hydrogen gas is generated is consumed or gone.

### EXAMPLES

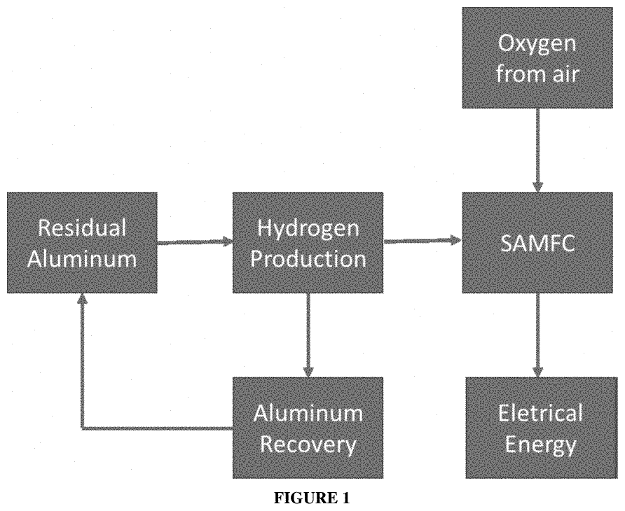

This disclosure provides for the generation of clean energy and the possibility of using residual materials. Aluminum is relatively inexpensive and such materials may be from products containing aluminum and then used as waste, for example soda cans. Although, the soft drinks are sources with little nutritional value, they are widely consumed around the world due to the taste and the diverse options. All cans of sodas, energy drinks or juices used become aluminum waste which could be used to produce energy. Considering, there are several other products that also generate discarded aluminum used by mankind Aluminum is the most industrially metallic element. Elemental aluminum is not found in nature, and during the mining there are negative environment impacts which are caused. Then, aluminum recycling is extremally beneficial for environment. There are many other advantages to the atmosphere, for example, the following reasons: hydrogen is a clean form of energy, and there is no need for external energy supply because the reaction occurs spontaneously, there is no pollution, the fuel generated (H₂) is pure and can be used in various applications such fuel cells to produce electricity and water and also the aluminum used may be alloys with different degrees of purity. In addition to all the advantages the aluminum hydroxide can be recycled for the reaction to continue to occur. It should be noted that the reaction by product Al(OH)₃ could also be used in other ways, like to produce other aluminum salts, and also for the use of hydroxides in pharmaceuticals, it could even be recovered for the use in electrolysis or some other convenient process. It is important to consider that this reaction is catalyzed by sodium or potassium hydroxides, which can also be completely recovered. It is possible to use residual aluminum to produce hydrogen, this is a sustainable way of producing hydrogen fuel. Then, using oxygen from air and hydrogen from the reaction with aluminum in the alkaline membrane fuel cell, so a sustainable FC is obtained that will be named SAMFC, as shown in the flow chart in FIG. 1.

In this example, a unit of SAMFC was constructed and evaluated. Results are compared with AMFC.

Materials and Methods

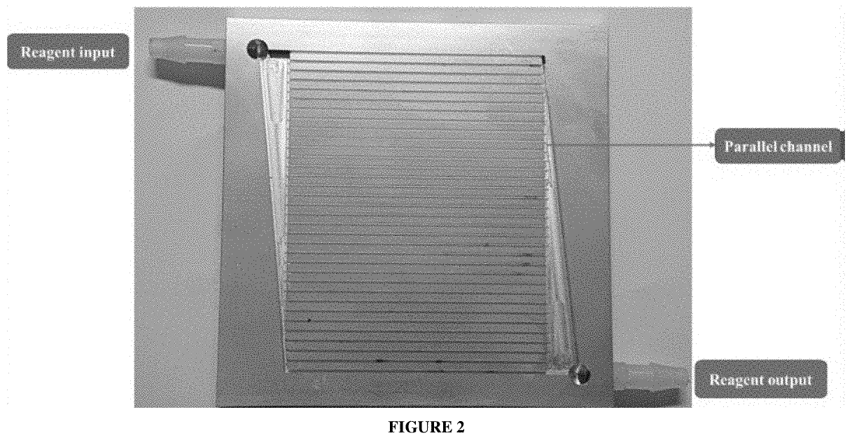

Fuel cell experimental set up: Fuel cell configuration comprises two brass plates, FIG. 2, for reactants feeding (one for H₂ and another for O₂). Those were developed having a side area of 144 cm² and 1 cm of thickness. In the plate there are parallel channels for gaseous flow.

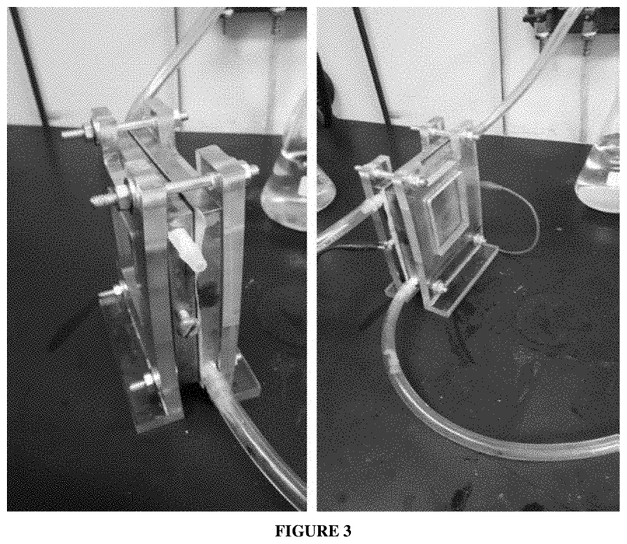

There are two platinum electrodes, for cathode and anode side. Between the electrodes there is an anionic cellulosic membrane saturated with KOH (40% w/w) placed in the middle of the FC. The membrane is comprised of filter paper with a specially designed composition for proper electrolyte absorption and durability, providing a novel and inexpensive method of introducing the potassium hydroxide electrolyte in the cell. An acrylic support was also built to facilitate assembly, there is no need to keep the cell suspended or the use of insulation to prevent contact between the metal parts. FIG.3shows the fuel cell assembly.

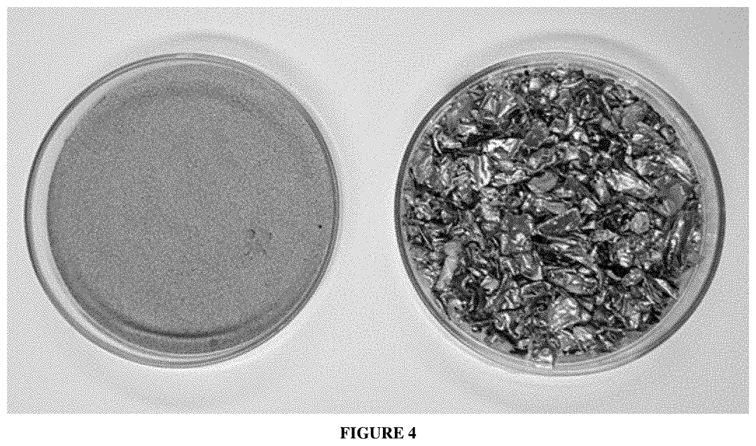

The experiment was carried out with commercial hydrogen (99.5%) and in a sustainable manner with hydrogen from aluminum. Hydrogen was produced by the hydrolysis of the water with aluminum using as catalyst potassium hydroxide (1.5 M). Both commercial and residual aluminum were used for the hydrogen production reaction, as shown in FIG. 4.

The residual aluminum came from soda cans. Those cans were inserted into a TRF 300G forage crusher to increase the contact area of Al with the aqueous solution and thereby increase reaction kinetics. The unit cell was fed with hydrogen from the hydrolysis with aluminum in the presence of the catalyst (for commercial and residual). Oxygen was obtained from the air by a compressor and to eliminate CO2, the air passed through an aqueous solution of KOH (20% w/w) to remove the carbon dioxide. The tests were performed and the data collected and presented in the polarization curves.

Results and Discussion

In this section, the AMFC and SAMFC unitary prototype behavior were studied experimentally. The experiment data were acquired and based on these values, graphs were plotted with results for hydrogen obtained from commercial and residual aluminum. Each graph evaluates two main properties, voltage(V) in the left axle (Volts) and power (P) in the right axle (Watts), both as current (i) function, in Ampere. Voltage and currents were measured in multimeters, afterwards the resistance was manually increased in the nickel-chrome alloy wire in the system to obtain polarization curves. The results for AMFC one single cell obtained with hydrogen from commercial are show in FIG. 5.

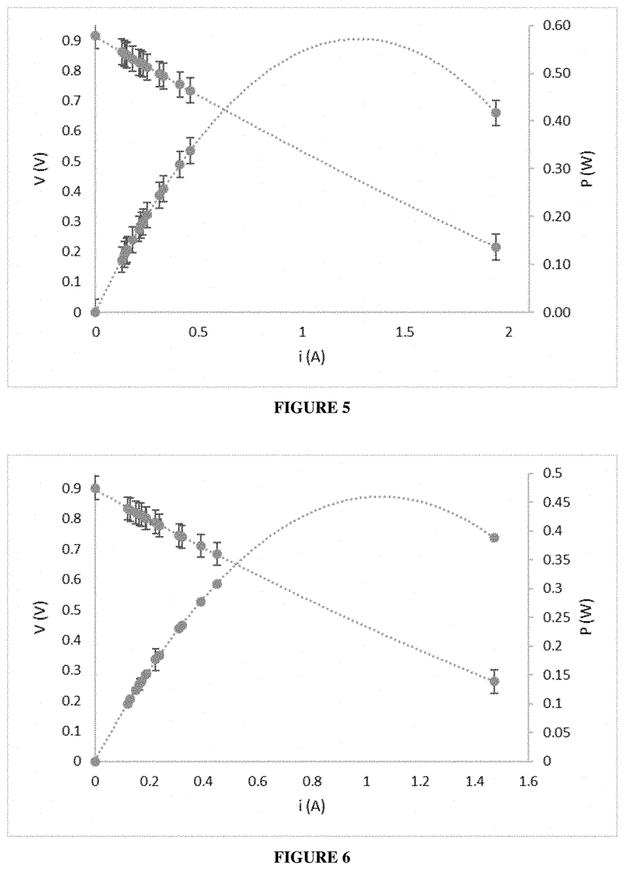

The voltage was 0.95 V for open circuit. The theoretical voltage for thermodynamic equilibrium is 1.23 V, under operating conditions this value is about 0.7 V. In this system the value is better than proposed in literature. The maximum power obtained experimentally was 0.42 W. The same experiment was made in a sustainable manner, using hydrogen from commercial aluminum reaction with water. FIG. 6 show polarization curve for SAMFC.

The voltage was 0.90V for open circuit. The voltage was a little reduced comparing with commercial hydrogen, but bigger than the theoretical voltage. For one single cell SAMFC the power was 0.39W, 9% of reduction comparing with AMFC.

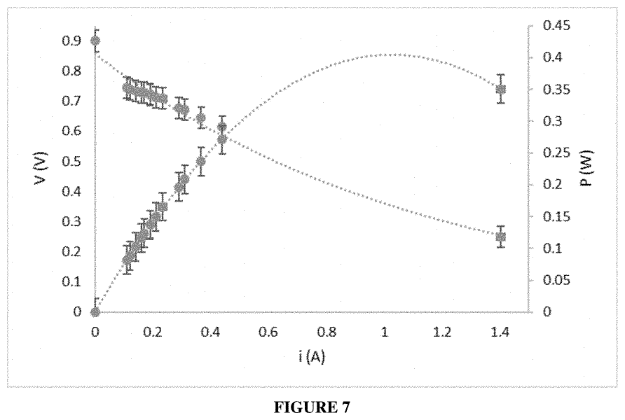

FIG. 7 shows polarization curve for SAMFC, using hydrogen from soda can aluminum. For sustainable FC the voltage was also 0.90 V for open circuit. The voltage did not change using commercial or residual aluminum to produce hydrogen. The power maximum power obtained was 0.35 W, there was 12.8% off comparing hydrogen obtained from commercial and residual aluminum.

Analyzing the power curves as current function, the quadratic equations representing these functions were achieved by experimental data. The maximum power values were calculated by equations for each presented situation. Maximum calculated powers are 1.28 W, 1.06 W and 1.03 W for FIGS. 5, 6 and 7, respectively. No work of AMFC using cellulose membrane was found in the literature. While the voltage, current and power values obtained experimentally are in the same magnitude of other works in different circumstances.

In summary, a SAMFC for a unit cell were designed and built with a cellulosic electrode. Voltage and power measurements were obtained in the laboratory prototype. The polarization curves were analyzed and compared for AMFC and SAMFC. Both can be presented as an energy provider. Voltage, current and power were obtained using commercial hydrogen and hydrogen obtained from commercial and residual aluminum, in a sustainable way. The performance were 0.95 V and 0.42W for AMFC V, for SAMFC 0.39W and 0.90 V, using hydrogen from pure aluminum and 0.90 V and 0.35 W using hydrogen from aluminum from soda can. This technology has a great feasible to be used industrially and the main point of view of this work was that the use of this new kind of membrane as an electrolyte provide an efficient option, accessible and not harmful to humans and the environment. In a society which looks for sustainability, it is highlighted the use of hydrogen that was obtained from aluminum commercial and residual. Being a source of cheap raw material, abundant in nature and it can be used of recycled products like the soda cans, as used in this work, and it can be fully recycled. Based on the results obtained, the polarization curves, the SAMFC unit cell area good, sustainable alternative energy source being able to complement or even to replace the existing fossil fuels source of energy.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

What is claimed is:

1. A real time hydrogen self-supplied alkaline membrane fuel cell that operates with hydrogen produced in situ, the fuel cell comprising,
a) a hydrogen generation reactor that provides continuous, on-demand supply of hydrogen, wherein the hydrogen generation reactor produces a fuel stream comprising hydrogen by reacting metal particles selected from the group consisting of aluminum, magnesium, silicon, zinc, and combinations thereof, with water in the presence of an alkaline catalyst, and
b) a membrane electrode assembly adapted to receive an oxidant and a fuel stream containing hydrogen produced in the hydrogen generation reactor,
wherein the membrane electrode assembly comprises an electrolyte membrane and at least two electrodes,
wherein the electrolyte membrane comprises cellulose, and
wherein the fuel cell uses aqueous potassium hydroxide as the electrolyte.

2. The fuel cell of claim 1, wherein the hydrogen generation reactor is a hydrogen generation batch reactor which receives intermittent supply of water, alkaline catalyst, and metal particles.

3. The fuel cell of claim 2, wherein the hydrogen generation reactor is configured to self-clean prior to receiving a supply of reactant.

4. The fuel cell of claim 3, wherein the hydrogen generation reactor self-cleans using a programmable mechanism to remove by-products.

5. The fuel cell of claim 1, wherein the reaction between the metal particles and water produces metal hydroxide by-product in the hydrogen generation reactor, and wherein the metal hydroxide by-product is directed to an external metal recycling chain.

6. The fuel cell of claim 1, wherein the at least two electrodes comprise an anode and a cathode on opposite sides of the electrolyte membrane.

7. The fuel cell of claim 1, wherein the electrodes comprise platinum, carbon, iron, cobalt, a nickel anode, or a silver or iron phthalocyanine cathode.

8. The fuel cell of claim 1, wherein the membrane electrode assembly is configured to remove carbon dioxide from the oxidant prior to use.

9. The fuel cell of claim 1, wherein the membrane electrode assembly allows for the fuel stream and oxidant to react in two electrodes and anions to flow through the electrolyte.

14. The fuel cell of claim 1, wherein cellulose in the electrolyte membrane is in the form of cotton fibers or paper.

15. A method for operating an alkaline membrane fuel cell, the method comprising
a) generating a fuel stream comprising hydrogen from a hydrogen generation reactor that provides continuous, on-demand supply of hydrogen,
wherein the hydrogen generation reactor produces hydrogen by reacting metal particles selected from the group consisting of aluminum, magnesium, silicon, zinc, and combinations thereof, with water in the presence of an alkaline catalyst;
b) supplying a continuous, on-demand flow of fuel comprising the hydrogen generated from step a) to a membrane electrode assembly, wherein the membrane electrode assembly is adapted to receive an oxidant and the fuel stream;
c) generating water and power in the fuel cell, and
d) using at least some of the water generated from step c) to resupply water for the generation of hydrogen in step a).

16. The method of claim 15, wherein the metal particles comprise aluminum.

17. The method of claim 15, wherein the metal particles have an average particle size diameter of less than 10,000 microns.

18. The method of claim 15, wherein the alkaline catalyst comprises a base selected from sodium hydroxide, potassium hydroxide, or a mixture thereof.

19. The method of claim 15, wherein the reaction between the metal particles and water produces metal hydroxide by-product, and
wherein the metal hydroxide by-product is directed to an external metal recycling chain, and allowing a new batch of metal particles to be provided to the hydrogen generation reactor,
thereby forming a sustainable, energy cycle.

20. The method of claim 15, further comprising controlling the reaction between the metal particles and water to provide substantially pure hydrogen and/or purifying the hydrogen prior to feeding the fuel cell in order to reduce contamination in the electrode membrane assembly.

21. The method of claim 15, wherein the oxidant is oxygen.

22. The method of claim 15, further comprising removing carbon dioxide from the oxidant prior to use.

23. The method of claims 22, wherein the fuel and oxidant react in two electrodes of the membrane electrode assembly and anions flow through a potassium hydroxide electrolyte.

24. A method for generating power from an alkaline membrane fuel cell, the method comprising
a) generating a fuel stream comprising hydrogen from a hydrogen generation reactor that provides continuous, on-demand supply of hydrogen,
wherein the hydrogen generation reactor produces hydrogen by reacting metal particles selected from the group consisting of aluminum, magnesium, silicon, zinc, and combinations thereof, with water in the presence of an alkaline catalyst;
b) supplying a continuous, on-demand flow of fuel comprising the hydrogen generated from step a) to a membrane electrode assembly, wherein the membrane electrode assembly is adapted to receive an oxidant and the fuel stream; and
c) generating water and power in the fuel cell, and
d) optionally using at least some of the water generated from step c) to resupply water for the generation of hydrogen in step a).

25. The method of claim 24, wherein the metal particles comprise aluminum obtained from a post-consumer waste product.

26. The method of claim 24, wherein the oxidant is oxygen is atmospheric air.
